(19) United States
(12) Patent Application Publication
(10) Pub. No.: US 2024/0287364 A1
(43) Pub. Date: Aug. 29, 2024

(54) ONE-COMPONENT POLYURETHANE ADHESIVE COMPOSITION

(71) Applicant: DDP SPECIALTY ELECTRONIC MATERIALS US, LLC, WILMINGTON, DE (US)

(72) Inventors: SERGIO GRUNDER, FREIENBACH (CH); DANIEL SCHNEIDER, FREIENBACH (CH); FILIPPO ARDIZZONE, FREIENBACH (CH)

(21) Appl. No.: 18/569,270

(22) PCT Filed: Jul. 8, 2022
(86) PCT No.: PCT/US22/36488

§ 371 Date: Dec. 12, 2023

Related U.S. Application Data
(60) Provisional application No. 63/238,476, filed on Aug. 30, 2021.

(51) Int. Cl. C09J 175/08; C08G 18/10; C08G 18/22; C08G 18/32; C08G 18/48

(52) U.S. Cl. CPC C09J 175/08; C08G 18/10; C08G 18/227; C08G 18/3253; C08G 18/4829

(57) ABSTRACT

Provided herein is a one-component polyurethane adhesive composition.

### FIELD OF INVENTION

The present invention relates to the field of one-component, moisture-curable polyurethanes adhesive compositions.

### BACKGROUND OF THE INVENTION

One part moisture-curing polyurethane adhesives (“1 K PU”) are used extensively in the automotive industry. Commercial adhesives are designed to offer both strong adhesion performance and good physical properties.

Typical paste 1 K PU adhesives are based on an isocyanate-functional prepolymer with terminal isocyanate (NCO) groups. The prepolymers are made by reacting an excess of diisocyanates with a polyol or polyols to form the NCO-terminated prepolymers. As a consequence of this method of synthesis, excess monomeric diisocyanates remain as contaminants.

In use, 1 K PU adhesives are applied, and then react with atmospheric moisture to form a carbamic acid, which decomposes to an amine and carbon dioxide. The resulting amine, reacts with remaining isocyanate groups to crosslink to form urea linkages and cure the adhesive (Equation 1). The advantage of 1 K PU adhesives is based on the fact that they are based on just one component and therefore no mixing is needed and the application is very simple.

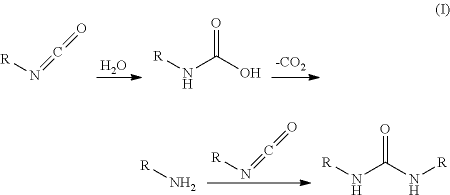

A disadvantage of 1 K PU adhesives is that they comprise residual diisocyanate monomers that are considered to be toxic. New regulations require that the residual diisocyanate content be below 0.1%, otherwise the user needs to be trained specifically (https://echa.europa.eu/registry-of-restriction-intentions/-/dislist/details/0b0236e180876053).

One way to reduce the monomeric diisocyanate content is to remove the excess monomers by distillation, however, this process is expensive, time- and energy-consuming and therefore not preferred. It would be preferable to formulate the 1 K PU adhesives in absence of isocyanates to remove the potential hazardous risks.

### SUMMARY OF THE INVENTION

In a first aspect, the invention provides a one-component, moisture-curable polyurethane adhesive composition comprising:
(A) a polyurethane prepolymer made by reacting at least one polyisocyanate and at least one polyol (resulting in Intermediate 1), followed by reaction with a molecule of Formula I:

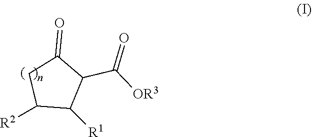

where R¹ and R² are independently selected from hydrogen and C₁ to C₆ alkyl, n is an integer from 1 to 2, and R³ is C₁ to C₆ alkyl;
(B) a polyamine in which the amine groups are blocked with a group that is cleaved on exposure to humidity;
(C) optionally a catalyst capable of catalyzing the reaction of an amine with the moiety resulting from the molecule of Formula 1.

In a second aspect, the invention provides a method for adhering a first substrate and a second substrate, comprising the steps:
(1) applying an adhesive composition according to the invention to the first substrate, the second substrate or both;
(2) bringing the first substrate and the second substrate into adhesive contact;
(3) allowing the adhesive composition to cure by exposure to humidity.

In a third aspect, the invention provides a method for adhering two substrates, comprising the steps:
(1) providing a one-component, moisture-curable polyurethane adhesive composition according to the invention;
(2) applying the adhesive composition to a first substrate, a second substrate, or both;
(3) placing the first and second substrates in adhesive contact, whereby the adhesive composition is sandwiched between them; and
(4) allowing the adhesive composition to cure.

In a fourth aspect, the invention provides an adhered assembly comprising:
(1) a first substrate;
(2) a second substrate;
(3) a one-component, moisture-curable polyurethane adhesive composition according to the invention;
wherein the first and second substrates are in adhesive contact with the adhesive composition sandwiched between them.

### DETAILED DESCRIPTION OF THE INVENTION

The inventors have found that an isocyanate functional prepolymer can be blocked so that no residual isocyanate groups remain. Those blocked prepolymers are stable and do not react with moisture. In combination with the blocked prepolymer, a second compound based on a polyfunctional blocked amine (e.g. polyaldimine or polyoxazolidine) is added to the formulation. The blocked amine reacts with moisture to form an amine, which on the other hand can react with the blocked PU-prepolymer to crosslink and form the cured polyurethane network. Hence, a moisture curing one-component polyurethane adhesive composition can be formulated without comprising any isocyanates at all. The reaction with an oxazolidine is depicted schematically below.

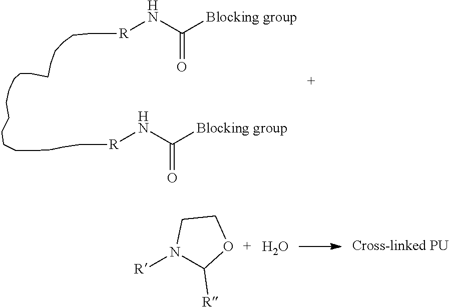

### Definitions and Abbreviations

MDI Methylenebis(phenyl isocyanate)
HDI Hexamethylene diisocyanate
IPDI isophorone diisocyanate
PU polyurethane
SEC size exclusion chromatography
RH relative humidity

Molecular weights of polymers as reported herein are reported in Daltons (Da) as number or weight average molecular weights, as determined by size exclusion chromatography (SEC).

### Polyisocyanate and Polyol

The inventive compositions comprise a polyurethane prepolymer made by reacting at least one polyisocyanate and at least one polyol (resulting in Intermediate 1), followed by reaction with at least one molecule of Formula I, in an amount to react all NCO groups.

The at least one polyol is preferably selected from polyether polyols, polyester polyols (e.g. polycaprolactone), polybutadiene diols, polycarbonate diols, aliphatic diols (polyols), and mixtures of any of these. Polyether polyols are particularly preferred.

The at least one polyol is preferably a diol, triol or tetra-ol. Preferably it is a triols or a mixture of a triol and a diol, with triols being particularly preferred.

Polyether polyols useful in the invention include for example, polyether polyols, poly(alkylene carbonate)polyols, hydroxyl containing polythioethers, polymer polyols, and mixtures thereof. Polyether polyols are well-known in the art and include, for example, polyoxyethylene, polyoxypropylene, polyoxybutylene, and polytetramethylene ether diols and triols which may be prepared, for example, by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound. Preferred polyether polyols contain one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. In the embodiment where a mixture of alkylene oxide units is contained in a polyol, the different units can be randomly arranged or can be arranged in blocks of each alkylene oxides. In one preferred embodiment, the polyol comprises propylene oxide chains. In a preferred embodiment, the polyether polyols are a mixture of polyether diols and polyether triols. Preferably, the polyether polyol or mixture has a functionality of at least about 2.0; and is preferably about 3.0 or greater, for example, 3.5, 4.0 or greater. Preferably, the equivalent weight of the polyether polyol mixture is at least about 200, more preferably at least about 500, and is more preferably at least about 1,000; and is preferably no greater than about 5,000, more preferably no greater than about 3,000.

More specific examples of polyether polyols include:
1. Difunctional polyols (diols), such as poly(alkylene oxide)diols, where the alkylene group is C₂ to C₄, particularly poly(ethylene oxide)diol, poly(propylene oxide)diol, poly(butylene oxide) diol and poly(tetramethylene oxide)diol, with poly(propylene oxide)diol being particularly preferred. In a particularly preferred embodiment the polyether polyol comprises a nominally difunctional, poly(propylene oxide) having an equivalent weight of from 100 to 10,000, more preferably 500 to 3,000, particularly preferably 1,000 to 2,000;
2. Trifunctional polyols (triols), such as those based on the akylene oxides initiated with a trifunctional polyol, such as trimethylolpropane, where the alkylene group is C₂ to C₄, particularly ethylene oxide, propylene oxide, butylene oxide, tetramethylene oxide and butylene oxide, with propylene oxide being particularly preferred. In a particularly preferred embodiment, the polyether polyol comprises a nominally trifunctional poly(propylene oxide) having an equivalent weight of from 100 to 10,000, more preferably 500 to 3,000, particularly preferably 1,000 to 2,000; the polymer may or may not be capped with ethylene oxide to modify reactivity.
3. A mixture of 1 and 2. Particularly preferred is a mixture of 1 and 2, more particularly preferred is a mixture of a) a nominally difunctional, poly(propylene oxide) having an equivalent weight of from 100 to 10,000, more preferably 500 to 3,000, particularly preferably 1,000 to 2,000 and b) a nominally trifunctional poly(propylene oxide) and equivalent weight of 1,000 to 2,000, particularly at a weight ratio b)/a) of 0:1-2:1.

In a particularly preferred embodiment, the at least one polyol comprises a propylene oxide based triol. Preferably the polypropylene oxide based triol has a molecular weight of from 1,000 to 5,000 Da, more preferably 1,000 to 3,000 Da.

Polyester polyols include any hydroxyl terminated polyesters. Particularly preferred are hydroxyl terminated aliphatic polyesters and polycaprolactone.

Polyester diols and triols are preferred, particular polyester triols. Particularly preferred are copolyesters having molecular weight of 2,000-4,000 Da, preferably 3,500 Da.

The polyisocyanate that may be used to make Intermediate I is not particularly limited. Preferred are diisocyanates.

Aliphatic and aromatic diisocyanates may be used, with aliphatic being preferred. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), methylene diphenyl diisocyanate (MDI, in particular 4,4′- and 4,2-MDI) and isophorone diisocyanate (IPDI), with HDI being particularly preferred.

In a preferred embodiment, Intermediate I is made by reacting a polyether triol with HDI. In a particularly preferred embodiment it is made by reacting a polypropylene oxide based triol with HDI. In a more particularly preferred embodiment it is made by reacting a polypropylene oxide based triol of molecular weight 4,800 with HDI.

In a preferred embodiment, Intermediate I is made by reacting an aliphatic polyester of molecular weight 3,500 with MDI. In a particularly preferred embodiment, the polyester prepolymer is made be reacting 65 to 80 wt % polyester diol with 5 to 15 wt % MDI.

Intermediate I may comprise a mixture of a polyether polyol-based prepolymer and a polyester-based prepolymer.

In a particularly preferred embodiment, Intermediate I is based on a polyether diol and a polyether triol.

The diisocyanate that may be used to make Intermediate I is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), with HDI being particularly preferred.

In a particularly preferred embodiment, Intermediate I comprises a nominally trifunctional poly(propylene oxide) and a nominally trifunctional poly(propylene oxide), reacted with MDI or HDI.

In a particularly preferred embodiment, Intermediate I comprises a nominally trifunctional poly(propylene oxide) having a hydroxyl number of 56 (equivalent weight 1000) and a nominally trifunctional poly(propylene oxide) having a hydroxyl number of 36 (equivalent weight 1558), reacted with MDI or HDI.

Intermediate I is made by reacting the at least one polyol with the polyisocyanate, using a catalyst capable of catalyzing the reaction of an NCO group with a hydroxyl group. Preferred catalysts are mentioned below.

Polymerisation may be carried out in the presence of a plasticizer, such as a high boiling ester or diester, for example diisononyl phthalate. Diisononyl phthalate is particularly preferred.

In a preferred embodiment, Intermediate I comprises 18 to 30 wt % polyol diol, more preferably 19 to 25 wt %, more particularly preferably 22 to 23 wt %, based on the total weight of Intermediate I.

In a preferred embodiment, Intermediate I comprises 40 to 90 wt % polyol triol, 50 to 90 wt %, more particularly preferably 75 to 85 wt %, based on the total weight of Intermediate I.

In a preferred embodiment, Intermediate I comprises 5 to 15 wt % diisocyanate, more preferably 8 to 12 wt %, more particularly preferably 8 to 10 wt %, based on the total weight of Intermediate I.

In a particularly preferred embodiment, Intermediate I comprises 22 to 23 wt % polyol diol, 32 to 33 wt % polyol triol, and 9 to 11 wt % diisocyanate, based on the total weight of Intermediate I.

In a preferred embodiment, Intermediate I comprises 18 to 30 wt % of a nominally difunctional, poly(propylene oxide) having a hydroxyl number of 56 (equivalent weight 1000), more preferably 19 to 25 wt %, more particularly preferably 22 to 23 wt %, based on the total weight of Intermediate I.

In a preferred embodiment, Intermediate I comprises 25 to 40 wt % of a nominally trifunctional poly(propylene oxide) having a hydroxyl number of 36 (equivalent weight 1558), 28 to 35 wt %, more particularly preferably 32 to 33 wt %, based on the total weight of Intermediate I.

In a preferred embodiment, Intermediate I comprises 5 to 15 wt % MDI or HDI, more preferably 8 to 12 wt %, more particularly preferably 9 to 11 wt %, based on the total weight of Intermediate 1.

In a particularly preferred embodiment, Intermediate I comprises 22 to 23 wt % of a nominally difunctional, poly(propylene oxide) having a hydroxyl number of 56 (equivalent weight 1000), 32 to 33 wt % of a nominally trifunctional poly(propylene oxide) having a hydroxyl number of 36 (equivalent weight 1558), and 9 to 11 wt % MDI, based on the total weight of Intermediate 1.

In a particularly preferred embodiment, Intermediate I comprises 22 to 23 wt % of a nominally difunctional, poly(propylene oxide) having a hydroxyl number of 56 (equivalent weight 1000), 32 to 33 wt % of a nominally trifunctional poly(propylene oxide) having a hydroxyl number of 36 (equivalent weight 1558), and 9 to 11 wt % MDI, based on the total weight of Intermediate I, and has an isocyanate content of 1.25% by weight, and a viscosity of 16,000 cps at 23° C. as measured according to the procedure described in U.S. Pat. No. 5,922,809 at column 12, lines 38 to 49.

### End Group (Molecule of Formula I)

The prepolymer is made by reacting the at least one polyisocyanate with the at least one polyol (resulting in Intermediate 1), followed by reaction with a molecule of Formula I:

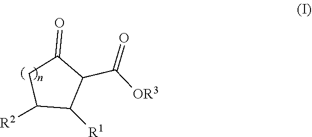

where R¹ and R² are independently selected from hydrogen and C₁ to C₆ alkyl, n is an integer from 1 to 2, and R³ is C₁ to C₆ alkyl;

Preferably R¹ and R² are independently selected from H and C₁ to C₄ alkyl, more preferably H and C₁ to C₂ alkyl, particularly preferably R¹ and R² are H.

Preferably n is 1.

Preferably R³ is C₁ to C₄ alkyl, more preferably R³ is C₁ to C₂ alkyl, particularly preferably R³ is ethyl.

In a particularly preferred embodiment, in the molecule of Formula I, R¹ and R² are H, n is 1, and R³ is ethyl [2-(ethoxycarbonyl)cyclopentanone, CPEE].

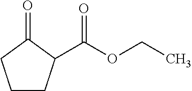

The molecule of Formula I reacts with the NCO groups of Intermediate I. It is preferably used in an amount that will react with all NCO groups of the Intermediate I, meaning at least an amount that is stoichiometrically equivalent to the free NCO groups of Intermediate I, or an excess, for example 1, 1.1 or 1.2 equivalents.

In order to reduce or eliminate any monomeric diisocyanate in Intermediate I, the amount or molecule of Formula I that is added may be calculated to react not only with the NCO groups of Intermediate I, but also with any residual monomeric diisocyanate. This essentially eliminates all NCO groups, both in the prepolymer and free monomeric diisocyanate.

### Catalyst for Polyurethane Prepolymer

Intermediate I is made by reacting the at least one polyisocyanate with the at least one polyol in the presence of a catalyst capable for catalysing the reaction of an NCO functionality with an OH functionality.

Examples of such catalysts include tertiary amine catalysts, bismuth catalysts alkyl tin carboxylates, oxides and mercaptides. Specific examples include triethylenediamine, 1,4-diazabicyclo[2.2.2]octane, dimethylcyclohexylamine, dimethylethanolamine, and bis-(2-dimethylaminoethyl)ether, bismuth catalysts, dibutyltin dilaurate, stannous octoate, with bismuth catalysts being particularly preferred.

For reaction with the molecule of Formula I, a zinc catalyst, in particular a zinc carboxylate catalyst is preferred. In a preferred embodiment, a mixture of zinc and bismuth carboxylates is used.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate. Preferably the at least one organometallic catalyst is a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a particularly preferred embodiment, it is a bismuth catalyst.

The catalyst is preferably used at 0.05 to 2 wt %, more preferably 0.1 to 1 wt %, based on the total weight of the adhesive composition.

In a preferred embodiment, the catalyst is a zinc and bismuth catalyst, used at 0.05 to 0.3 wt % based on the total weight of the adhesive composition.

### Polyurethane Prepolymer

The polyurethane prepolymer resulting from reaction of Intermediate I and the molecule of Formula I, as detailed above, and any combination of polyol, polyisocyanate and molecule of Formula I is contemplated herein.

In a particularly preferred embodiment, the polyurethane prepolymer comprises 75-90 wt % of a polypropyleneoxide-based triol with a MW of 4800 g/mol, 5-10 wt % 1,6-HDI, and 5-10 wt % CPEE.

In a particularly preferred embodiment, the polyurethane prepolymer comprises 82.68 wt % of a polypropyleneoxide-based triol with a MW of 4800 g/mol, 8.68 wt % 1,6-HDI, and 8.54 wt % CPEE.

The polyurethane prepolymer is preferably present in the one-component polyurethane adhesive composition at 20-70 wt %, more preferably 30-55 wt %, more particularly preferably 35 to 40 wt % based on the total weight of the adhesive composition.

In a particularly preferred embodiment, the adhesive composition of the invention comprises 20-70 wt %, more preferably 35 to 40 wt % of a polyurethane prepolymer, based on the total weight of the adhesive composition, comprising a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI, and having an isocyanate content of 1.25% by weight, followed by reaction with a molecule of Formula I.

Preferably, the prepolymer or prepolymer mixture has a Brookfield viscosity of at least 6,000 centipoise or at least about 8,000 centipoise, and as much as 30,000 centipoise or as much as 20,000 centipoise. If the viscosity is too high, it will be difficult to pump the final adhesive composition. If the viscosity is too low, the final adhesive composition will be too runny and/or will sag.

Prepolymer equivalent and molecular weights are determined according to the procedure disclosed in U.S. Pat. No. 5,922,809 at column 12, lines 50 to 64, incorporated herein by reference.

In a preferred embodiment, the polyurethane prepolymer has a viscosity of 16,000 cps at 23° C. as measured according to the procedure described in U.S. Pat. No. 5,922,809 at column 12, lines 38 to 49.

In a particularly preferred embodiment, the polyurethane prepolymer has an isocyanate content of less than 0.1 wt %, more preferably 0% by weight.

In another preferred embodiment the polyurethane prepolymer has an isocyanate content of less than 0.1 wt %, more preferably 0% by weight, and a viscosity of 16,000 cps at 23° C. as measured according to the procedure described in U.S. Pat. No. 5,922,809 at column 12, lines 38 to 49.

The adhesive compositions of the invention preferably comprise the at least one polyurethane prepolymer in an amount of 1-90 wt %, more preferably 35-85 wt %, particularly preferably 40-50 wt %, based on the total weight of the adhesive composition.

In a particularly preferred embodiment, the adhesive composition comprises 40-50 wt %, particularly 44 wt % of a polyurethane prepolymer made by reacting a polypropylene oxide-based triol with HDI, followed by reaction with a molecule of Formula I.

In a particularly preferred embodiment, the adhesive composition comprises 40-50 wt %, particularly 44 wt % of a polyurethane prepolymer made by reacting a polypropylene oxide-based triol with HDI, followed by reaction with CPEE.

### Blocked Amine

The adhesive compositions of the invention comprise a polyamine, preferably a diamine or triamine, in which the amine groups are blocked or masked with a group that is cleaved on exposure to humidity.

Examples include:
1. Polyoxazolidines, which are molecules having two or more oxazolidine groups of the Formula II or III:

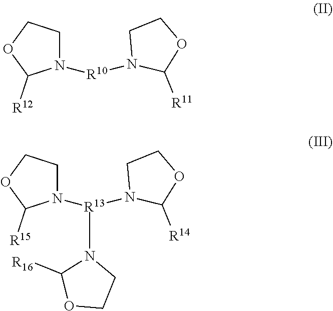

where, in Formula II, R¹⁰ is a branched or unbranched divalent organic radical, R¹¹ and R¹² are independently selected from H and branched or unbranched C₁-C₈-alkyl, and
in Formula III, R¹³ is a branched or unbranched trivalent organic radical, and R¹⁴, R¹⁵ and R¹⁶ are independently selected from H and branched or unbranched C₁-C₈-alkyl.
2. Aldimino groups of the Formula (IVa) or (IVb), ketimino groups, and enamino groups,

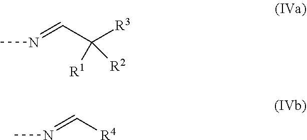

where in Formula IVa, R¹ and R² are independently selected from H and monovalent hydrocarbon radicals having 1 to 12 carbon atoms, or together are a divalent hydrocarbon radical having 4 to 20 carbon atoms and part of an optionally substituted carbocyclic having 5 to 8, preferably 6, carbon atoms, and
R³ is selected from H, branched or unbranched alkyl, cycloalkyl, alkenyl or cycloalkenyl, substituted or unsubstituted aryl, arylalkyl, and radicals of the formulae:

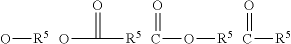

where R⁵ is selected from substituted and unsubstituted aryl, arylalkyl, alkyl, and radicals of the formula:

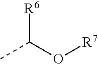

where R⁶ is selected from H, alkyl, and arylalkyl, preferably having 1 to 12 carbon atoms, preferably R⁶ is H, and R⁷ is a hydrocarbon radical having 1 to carbon atoms and optionally ether oxygen atoms, or R⁷ is of the formula:

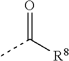

where R⁸ is selected from H, and hydrocarbon radicals having 1 to 5 carbon atoms,
And in Formula IVb, R⁴ is substituted or unsubstituted aryl or heteroaryl with a ring size of from 5 to 8, preferably 6 atoms, or is of the formula:

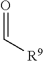

where R⁹ is H or an alkoxy group, or is substituted or unsubstituted alkenyl or arylalkenyl having at least 6 carbon atoms.

If a polyoxazolidine is used, it is preferably a bis-oxazolidine.

In preferred polyoxazolidines of Formula II, R¹⁰ is selected from alkylene, arylalkylene, arylene, heteroarylene, divalent polyether, divalent polyester, and divalent polyurethane. Polyurethane is particularly preferred.

Particularly preferred polyoxazolidines are of the Formula V, VI or XII:

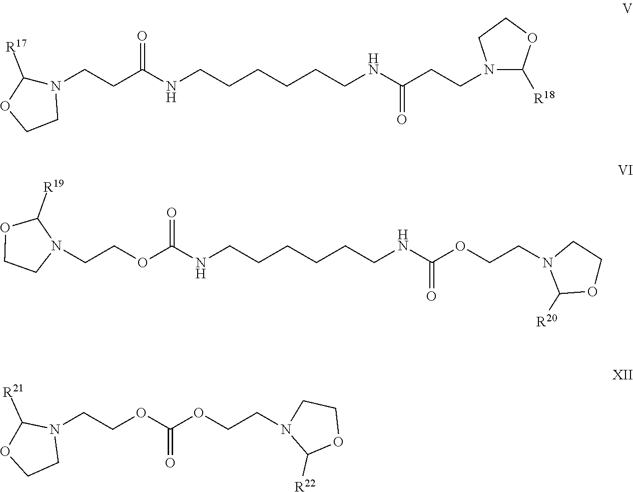

where in Formula V, R¹⁷ and R¹⁸ are independently selected from branched or unbranched C₁-C₈-alkyl, preferably C₇-alkyl or C₃-alkyl. Particularly preferably R¹⁷ and R¹⁸ are of the formula:

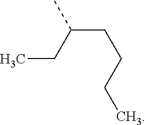

In Formula VI, R¹⁹ and R²⁰ are independently selected from branched or unbranched C₁-C₈-alkyl, preferably C₇-alkyl, particularly preferably 1-ethylpentyl.

In Formula XII, R²¹ and R²² are independently selected from branched or unbranched C₁-C₈-alkyl, preferably C₃₋₇-alkyl, preferably C₃-alkyl, particularly preferably R²¹ and R²² are of the formula:

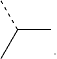

Very particularly preferred polyoxazolidines have the following Formulae:

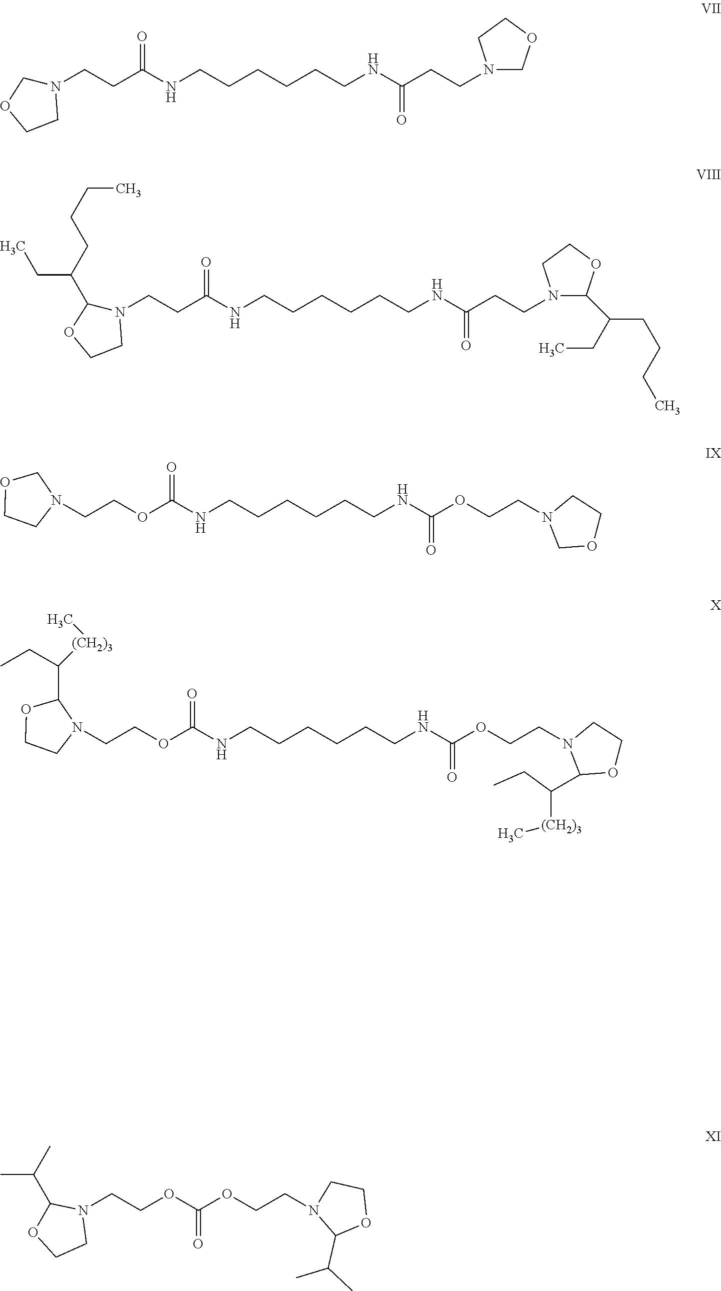

Particularly preferably, the polyoxazolidine is of Formula VIII or XI, more particularly preferably Formula VIII.

The blocked amine is preferably used at a ratio of amino groups to the end groups of the polyurethane prepolymer of 1:1.

### Method for Making the Polyurethane Prepolymer

An example of a method for manufacturing the polyurethane prepolymer comprised the following steps:
1. the at least one polyol is stirred under an inert atmosphere (e.g. nitrogen or argon), optionally in the presence of a plasticizer (e.g. diisononyl phthalate);
2. the at least one polyisocyanate is added;
3. the catalyst is added, resulting in Intermediate I;
4. once the desired NCO content is reached, the molecule of Formula I is added, preferably in an amount sufficient to react with all the NCO groups of Intermediate I.

A preferred embodiment of the method, comprises the following steps:
1. the at least one polyol is stirred under an inert atmosphere (e.g. nitrogen or argon), optionally in the presence of a plasticizer (e.g. diisononyl phthalate);
2. the at least one polyisocyanate is added in a ratio NCO:OH of from 1.5:1, 2:1, 4:1, 5:1 or higher;
3. the catalyst is added, resulting in Intermediate I;
4. once the desired NCO content is reached, the molecule of Formula I is added in a ratio NCO:Formula I of from 1 to 1.5, preferably 1 to 1.1.

In a preferred embodiment, the method of manufacture of the polyurethane prepolymer comprises the following steps:
1. the at least one polyol is stirred under an inert atmosphere (e.g. nitrogen or argon), optionally in the presence of a plasticizer (e.g. diisononyl phthalate), and heated to 65-150° C., followed by cooling to 60-80° C.;
2. the at least one polyisocyanate is added;
3. the catalyst is added, and the mixture is allowed to react at 60-100° C.;
4. once the desired NCO content is reached, the mixture of step 3 is cooled to 50-70° C. and the molecule of Formula I is added in a ratio NCO:Formula I of from 1 to 1.5, preferably 1 to 1.1.

### Method for Making Adhesive Composition

The adhesive compositions of the invention comprise the at least one polyurethane prepolymer, the at least one blocked amine, and optionally a catalyst. The adhesive compositions are made by mixing the ingredients to homogeneity, preferably under dry conditions. Once mixed, the adhesive composition is preferably stored under dry conditions, for example under vacuum or under dry nitrogen.

### Optional Ingredients

The adhesive compositions of the invention may optionally comprise a catalyst that is capable of catalyzing the reaction of an amine with the moiety resulting from the molecule of Formula I. Examples include bismuth neodecanoate. If used, the catalyst is typically present at 0.1 to 0.5 wt %, based on the total weight of the adhesive composition.

The adhesive compositions of the invention may optionally comprise antioxidants, in particular phenolic antioxidants. Typical examples include 4,6-bis(octylthiomethyl)-o-cresol. If used, antioxidants are typically present at 0.2 to 1.5 wt %, preferably 0.3 to 0.6 wt %, based on the total weight of the adhesive composition. In a particularly preferred embodiment, 4,6-bis(octylthiomethyl)-o-cresol is used at 0.3 to 0.6 wt %, more preferably at 0.5-0.6 wt %, based on the total weight of the adhesive composition.

The adhesive compositions of the invention may optionally comprise a plasticizer. Examples of plasticizers are esters, in particular diesters and triesters, particularly those having vapour pressures of <10⁻⁴ hPa at 23° C. Examples include dialkyl phthalate esters, alkyl esters of fatty acids, phosphate esters (such as trioctyl phosphate). Diisononylphthalate is particularly preferred. If used, the plasticizer is typically present at 10 to 20 wt %, preferably 12 to 18 wt %, based on the total weight of the adhesive composition. In a particularly preferred embodiment, diisononylphthalate is used at 12 to 18 wt %, more preferably at 16-17 wt %, based on the total weight of the adhesive composition.

The adhesive compositions of the invention may optionally comprise fillers, such as carbon black, clay, carbonates (e.g. calcium carbonate), metal hydrates and fumed silica. The fillers are preferably used at from 0-80% preferably 10-70, more preferably 20-60 w %.

In a preferred embodiment, the adhesives of the invention comprise clay as filler, preferably kaolin, in particular calcined kaolin. If used, clay is used at 5 to 15 wt %, more preferably 8 to 12 wt %, based on the total weight of the adhesive composition. In a particularly preferred embodiment, kaolin is used at 8 to 12 wt %, more preferably at 9 wt %, based on the total weight of the adhesive composition.

In a preferred embodiment, the adhesives of the invention comprise carbon black as filler. The carbon black is not particularly limited. Preferred carbon blacks exhibit an oil absorption number of at least 80, preferably at least 90 and more preferably at least 95 cm³ of dibutyl phthalate per 100 g of carbon black, as measured according to ASTM D-2414-09. In addition, the carbon black desirably has an iodine number of at least 80, determined according to ASTM D1510-11.

If used, carbon black is used at 5-30 wt %, more preferably 15 to 25 wt %, based on the total weight of the adhesive composition. In a particularly preferred embodiment, carbon black is used at 15 to 25 wt %, preferably 22 to 23 wt %, based on the total weight of the adhesive composition.

The adhesive compositions of the invention may optionally comprise calcium carbonate at 0-20 wt %, more preferably 5 to 15 wt %, particularly preferably 9-10 wt %, based on the total weight of the adhesive composition. The calcium carbonate particles may be untreated or surface modified by treatment with chemicals, such as organic acids or esters of organic acids.

The adhesive compositions of the invention may optionally comprise fumed silica at 0-1.5 wt %, more preferably 0.5 to 1 wt %, based on the total weight of the adhesive.

If fumed silica is used, the particles may be untreated or surface modified by treatment with chemicals, such as chlorosilane, dichlorosilane, alkyltrialkoxysilane or polydimethylsiloxane.

The adhesive compositions of the invention may optionally comprise flame-retardants and synergists. Examples of suitable flame-retardants and synergists include:
1. aluminium, zinc and titanium salts of diethylphosphinate, in particular aluminium diethylphosphinate;
2. nitrogen and/or phosphorus containing molecules, such as melamine polyphosphate, melamine pyrophosphate, melamine cyanurate;
3. aluminium and/or zinc phosphites

A preferred combination of flame-retardants/synergists is aluminium diethylphosphinate plus melamine polyphosphate.

If it is desired that the adhesive compositions of the invention have a high thermal conductivity (>2 Wm⁻¹K⁻¹), a thermally conductive filler may be added, such as aluminium oxide or aluminium hydroxide.

The adhesive compositions of the invention may optionally comprise one or more additional stabilizers, for example heat, visible light and UV-stabilizers. Examples of heat stabilizers include alkyl substituted phenols, phosphites, sebacates and cinnamates. If present, a preferred heat stabilizer is an organophosphite and more specifically trisnonylphenyl phosphite as disclosed in U.S. Pat. No. 6,512,033, incorporated herein by reference. The heat stabilizer may constitute at least 0.01 or at least 0.3 weight percent based on the entire weight of the adhesive composition, up to at most 5 weight percent, up to 2 weight percent or up to 1.0 weight percent. The adhesive composition may be devoid of such a heat stabilizer.

For UV light stabilizers, they include benzophenones and benzotriazoles. Specific UV light absorbers include those from BASF such as TINUVIN™ P) TINUVIN™ 326, TINUVIN™ 213, TINUVIN™ 327, TINUVIN™ 571, TINUVIN™ 328, and from Cytec such as CYASORB™ UV-9, CYASORB™ UV-24, CYASORB™ UV-1164, CYASORB™ UV-2337, CYASORB™ UV-2908, CYASORB™ UV-5337, CYASORB™ UV-531, and CYASORB™ UV-3638. Among these, TINUVIN™ 571 is preferred. One or more UV light absorbers may constitute at least 0.1 weight percent, at least 0.2 weight percent or at least 0.3 parts by weight of the weight of the adhesive composition, and may constitute up to 3 weight percent, up to 2 weight percent or up to 1 weight percent thereof.

The adhesive composition of the invention may further include one or more visible light stabilizers. Preferred visible light stabilizers included hindered amine visible light stabilizers such as TINUVIN™ 144, TINUVIN™ 622, TINUVIN™ 77, TINUVIN™ 123, TINUVIN™ 765, CHIMASSORB™ 944 available from Cytec; CYASORB™ UV-500, CYASORB™ UV-3581, CYASORB™ UV-3346, all available from Ciba-Geigy. Among these, TINUVIN™ 765 is preferred choice. The visible light stabilizer(s) may constitute at least 0.1 weight percent, at least 0.2 weight percent or at least 0.3 weight percent of the adhesive composition, and may constitute up to 3 weight percent, up to 2 weight percent or up to 1.5 weight percent thereof.

### Method of Manufacture

The adhesive compositions of the invention are made by mixing the ingredients under inert and dry conditions and/or under vacuum, until a homogenous mixture is obtained.

The resulting adhesive composition may be packaged, for example, it may be packaged into airtight containers, such as airtight tubes which are stored in nitrogen filled sealed aluminium bags.

### Method of Use

In a second aspect, the invention provides a method for adhering two substrates, comprising the steps:
(1) providing a one-component, moisture-curable polyurethane adhesive composition according to the invention;
(2) applying the adhesive composition to a first substrate, a second substrate, or both;
(3) placing the first and second substrates in adhesive contact, whereby the adhesive composition is sandwiched between them; and
(4) allowing the adhesive composition to cure.

As mentioned above, a preferred way of providing the adhesive of the invention is in airtight containers, such as airtight sealed tubes. The containers are opened immediately prior to use.

The adhesive composition of the invention may be applied by any application method, manually or with robotic equipment, including, for example, by spreading, application through a nozzle.

In a preferred embodiment one or both of the first and second substrates are selected from metal, glass, glass with primer, glass with enamel coating, plastic (e.g. polypropylene, for example with talc or glass fiber), polycarbonate, sheet molded compounds, composites (e.g. carbon fiber reinforced epoxy, glass fibre reinforced polyamide). In a preferred embodiment, at least one of the first and second substrates is metal, in particular steel or aluminium, particularly preferably e-coated steel, e-coated aluminium. In a particularly preferred embodiment, both substrates are steel.

Curing is carried out by exposing the adhesive composition to atmospheric moisture. Curing may take place at room temperature, or at elevated temperature, for example, 50° C. or greater or 70° C. or greater. Typical curing conditions include 3 to 7 days at 23° C. and 50% RH.

### Effect of the Invention

The adhesive compositions of the invention preferably show an NCO content, both monomeric contaminant and in the adhesive molecules of less than 0.1 wt %, more preferably 0 wt %.

The adhesive compositions of the invention show good adhesive properties. Using the lap shear adhesion test described in the Examples, the adhesive compositions of the invention, after curing for 7 days at 23° C., 50% RH, preferably show a lap shear strength of at least 1.5 MPa, more preferably greater than 2 MPa.

Using the lap shear strength test described in the Examples, the adhesive compositions of the invention, after curing for 7 days at 23° C., 50% RH, preferably show a lap shear strength of 360 psi or greater, more preferably 370 psi or greater.

Using the tensile strength test described in the Examples, the adhesive compositions of the invention, after curing for 7 days at 23° C., 50% RH.

Using the lap shear strength test described in the Examples, the adhesive compositions of the invention, after curing for 7 days at 23° C., 50% RH, preferably show a tensile strength of 1.5 MPa or greater, more preferably 2 MPa or greater.

Using the E-modulus test described in the Examples, the adhesive compositions of the invention preferably show an E-modulus of 1 MPa or greater, after curing for 7 days at 23° C., 50% RH.

Using the elongation at break test described in the Examples, the adhesive compositions of the invention preferably show an elongation at break of at least 200%, more preferably at least 300%, particularly preferably at least 400% after curing for 7 days at 23° C., 50% RH.

### Particularly Preferred Embodiments

The following are particularly preferred embodiments of the adhesive compositions of the invention:
1. A one-component, moisture-curable polyurethane adhesive composition comprising:
   (A) a polyurethane prepolymer made by reacting at least one polyisocyanate and at least one polyol (resulting in Intermediate 1), followed by reaction with a molecule of Formula I:

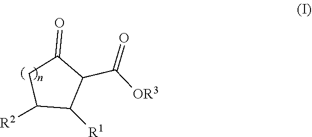

where R¹ and R² are independently selected from hydrogen and C₁ to C₆ alkyl, n is an integer from 1 to 2, and R³ is C₁ to C₆ alkyl;
(B) a polyamine in which the amine groups are blocked with a group that is cleaved on exposure to humidity;
(C) optionally a catalyst capable of catalyzing the reaction of an amine with the moiety resulting from the molecule of Formula I.
2. The adhesive composition of embodiment 1, wherein the at least one polyol is a polyether polyol or a polyester polyol.
3. The adhesive composition of embodiment 1 or 2, wherein the at least one polyol is a polyether polyol.
4. The adhesive composition of embodiment 1, 2 or 3, wherein the at least one polyol is a diol, triol or tetra-ol, or a mixture of these, in particular a mixture of a diol and a triol.
5. The adhesive composition of any one preceding embodiment, wherein the at least one polyol is selected from polyoxyethylene, polyoxypropylene, polyoxybutylene, and polytetramethylene ether diols and triols.
6. The adhesive composition of any one preceding embodiment, wherein the polyol is a polypropylene oxide-based diol or triol or a mixture of these.
7. The adhesive composition of any one preceding embodiment, wherein the polyol is a polypropylene oxide-based triol.
8. The adhesive composition of any one preceding embodiment, wherein the at least one polyisocyanate is a diisocyanate.
9. The adhesive composition of any one preceding embodiment, wherein the at least one polyisocyanate is an aliphatic polyisocyanate.
10. The adhesive composition of any one preceding embodiment, wherein the at least one polyisocyanate is hexamethylene diisocyanate (HDI) or 4,4′- or 4,2-Methylenebis(phenyl isocyanate).
11. The adhesive composition of any one preceding embodiment, wherein Intermediate I is made by reacting a polypropylene oxide based triol with HDI.
12. The adhesive composition of any one preceding embodiment, wherein Intermediate I is made by reacting a polypropylene oxide based triol of molecular weight 4,800 with HDI.
13. The adhesive composition of any one preceding embodiment, wherein the at least one polyol and the at least one polyisocyanate are reacted in the presence of a catalyst selected from bismuth catalysts, metal carboxylates such as tin carboxylates, bismuth carboxylates, zinc carboxylates, and mixtures of any of these, in particular a mixture of zinc and bismuth carboxylates.
14. The adhesive composition of any one preceding embodiment, wherein the at least one polyol and the at least one polyisocyanate are reacted in the presence of a catalyst selected from stannous octoate, bismuth octoate or bismuth neodecanoate.
15. The adhesive composition of any one preceding embodiment, wherein the at least one polyol and the at least one polyisocyanate are reacted in the presence of a catalyst that is a bismuth catalyst.
16. The adhesive composition of any one preceding embodiment, wherein the prepolymer comprises the at least one polyol in an amount from 40 to 95 wt % based on the total weight of the polyurethane prepolymer.
17. The adhesive composition of any one preceding embodiment, wherein the prepolymer comprises the at least one polyol in an amount from 50 to 90 wt % based on the total weight of the polyurethane prepolymer.
18. The adhesive composition of any one preceding embodiment, wherein the prepolymer comprises the at least one polyol in an amount from 75 to 85 wt % based on the total weight of the polyurethane prepolymer.
19. The adhesive composition of any one preceding embodiment, wherein the prepolymer comprises the at least one polyisocyanate in an amount from 4 to 15 wt % based on the total weight of the polyurethane prepolymer.
20. The adhesive composition of any one preceding embodiment, wherein the prepolymer comprises the at least one polyisocyanate in an amount from 5 to 10 wt % based on the total weight of the polyurethane prepolymer.
21. The adhesive composition of any one preceding embodiment, wherein the prepolymer comprises the at least one polyisocyanate in an amount from 7 to 9 wt % based on the total weight of the polyurethane prepolymer.
22. The adhesive composition of any one preceding embodiment, wherein in the molecule of Formula I, R¹ and R² are independently selected from H and C₁ to C₄ alkyl.
23. The adhesive composition of any one preceding embodiment, wherein in the molecule of Formula I, R¹ and R² are independently selected from H and C₁ to C₂ alkyl
24. The adhesive composition of any one preceding embodiment, wherein in the molecule of Formula I, R¹ and R² are H.
25. The adhesive composition of any one preceding embodiment, wherein in the molecule of Formula I, n is 1.
26. The adhesive composition of any one preceding embodiment, wherein in the molecule of Formula I, R³ is C₁ to C₄ alkyl
29. The adhesive composition of any one preceding embodiment, wherein in the molecule of Formula I, R³ is C₁ to C₂ alkyl
30. The adhesive composition of any one preceding embodiment, wherein in the molecule of Formula I, R³ is ethyl.
31. The adhesive composition of any one preceding embodiment, wherein the molecule of Formula I is ethyl 2-(ethoxycarbonyl)cyclopentanone (CPEE).
32. The adhesive composition of any one preceding embodiment, wherein the molecule of Formula I is used in an amount equivalent to or in excess of the NCO groups of Intermediate I.
33. The adhesive composition of any one preceding embodiment, wherein the molecule of Formula I is used in an amount of 1.1 to 1.2 with respect to the NCO groups of Intermediate I.
34. The adhesive composition of any one preceding embodiment, wherein the at least one prepolymer is made by reacting a polypropylene oxide-based triol with a polyisocyanate, followed by reacting with a molecule of Formula I.
35. The adhesive composition of any one preceding embodiment, wherein the at least one prepolymer is made by reacting a polypropylene oxide-based triol with HDI, followed by reacting with a molecule of Formula I.
36. The adhesive composition of any one preceding embodiment, wherein the at least one prepolymer is made by reacting a polypropylene oxide-based triol with HDI, followed by reacting with a molecule of Formula I that is CPEE.
37. The adhesive composition of any one preceding embodiment, wherein the at least one polyurethane prepolymer is made by reacting a polypropylene oxide-based triol with a molecular weight of 4,800 Da with HDI, followed by reacting with a molecule of Formula I, which is CPEE, wherein the polyol is used at 82-83 wt %, the HDI is used at 8-9 wt % and the CPEE is used at 8-9 wt %, based on the total weight of the polyurethane prepolymer.
38. The adhesive composition of any one preceding embodiment, wherein the polyamine in which the amine groups are blocked is an aldimine or a polyoxazolidine.
39. The adhesive composition of any one preceding embodiment, wherein the polyamine in which the amine groups are blocked is a dialdimine or a bis-oxazolidine.
40. The adhesive composition of any one preceding embodiment, wherein the polyamine in which the amine groups are blocked is a polyoxazolidine.
41. The adhesive composition of any one preceding embodiment, wherein the polyamine in which the amine groups are blocked is a bis-oxazolidine.
42. The adhesive composition of any one preceding embodiment, wherein the polyamine in which the amine groups are blocked is a polyoxazolidine of Formula II or Formula III:

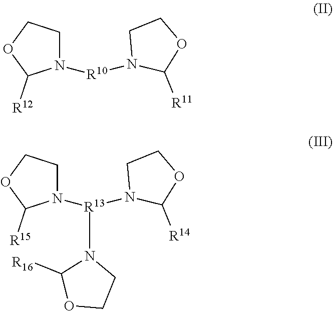

where, in Formula II, R¹⁰ is a branched or unbranched divalent organic radical, R¹¹ and R¹² are independently selected from H and branched or unbranched C₁-C₈-alkyl, and
in Formula III, R¹³ is a branched or unbranched trivalent organic radical, and R¹⁴, R¹⁵ and R¹⁶ are independently selected from H and branched or unbranched C₁-C₈-alkyl.
43. The adhesive composition of any one preceding embodiment, wherein the polyamine in which the amine groups are blocked is a polyoxazolidine of Formula V, Formula VI or Formula XII:

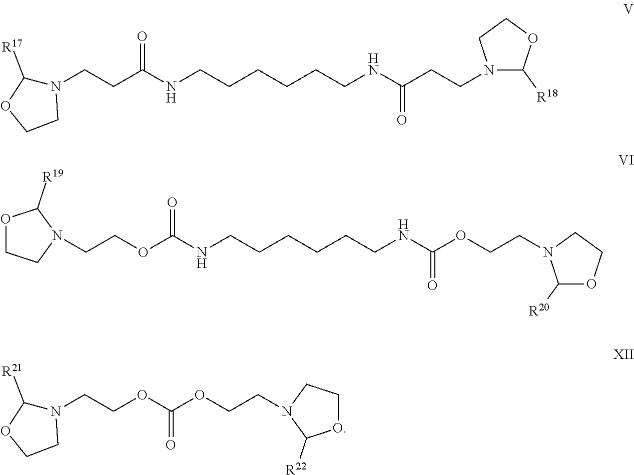

where in Formula V, R¹⁷ and R¹⁸ are independently selected from H and branched or unbranched C₁-C₈-alkyl, preferably C₇-alkyl, and in Formula VI, R¹⁹ and R²⁰ are independently selected from H and branched or unbranched C₁-C₈-alkyl, preferably C₇-alkyl, and in Formula XII, R²¹ and R²² are independently selected from branched or unbranched C₁-C₈-alkyl, preferably C₃-alkyl.
44. The adhesive composition of embodiment 43, wherein, in Formula V, R¹⁷ and R¹⁸ are of the formula:

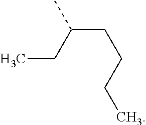

45. The adhesive composition of embodiment 43, wherein, in Formula VI, R¹⁹ and R²⁰ are 1-ethylpentyl.
46. The adhesive composition of embodiment 43, wherein, in Formula XII, R²¹ and R²² are of the formula:

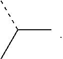

47. The adhesive composition of any one preceding embodiment, wherein the polyamine in which the amine groups are blocked is of the Formula VII, VIII, IX, X or XI:

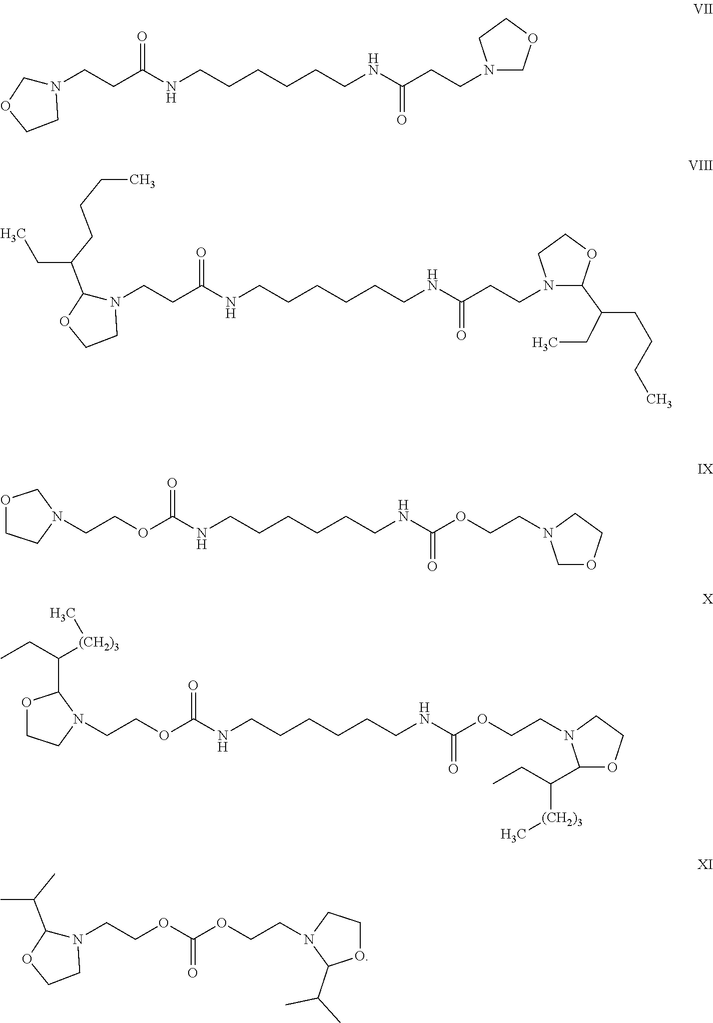

48. The adhesive composition of any one preceding embodiment, wherein the polyamine in which the amine groups are blocked is of the Formula VIII:

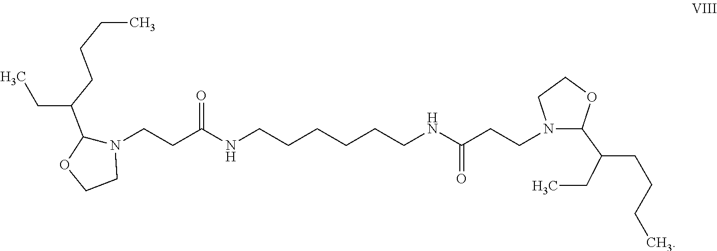 [SMILES: CCCCC(CC)C1OCCN1CCC(=O)NCCCCCCNC(=O)CCN1CCOC1C(CC)CCCC]

or Formula XI:

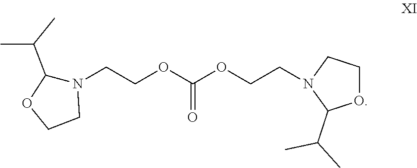 [SMILES: CC(C)C1OCCN1CCOC(=O)OCCN1CCOC1C(C)C]

preferably Formula VIII.
49. The adhesive composition of any one preceding embodiment, which comprises a catalyst capable of catalyzing the reaction of an amine with the moiety resulting from the molecule of Formula I.
50. The adhesive composition of any one preceding embodiment, which comprises a catalyst capable of catalyzing the reaction of an amine with the moiety resulting from the molecule of Formula I, which is bismuth neodecanoate.
51. The adhesive composition of any one preceding embodiment, wherein the polyurethane prepolymer is used at 20-70 wt %, more preferably 30-55 wt %, more particularly preferably 35 to 40 wt % based on the total weight of the adhesive composition.
52. The adhesive composition of any one preceding embodiment, wherein the ratio of amino groups in the polyamine in which the amine groups are blocked to the end groups of the polyurethane prepolymer is 1:1, 0.9:1, 1.0:0.9, 0.8:1, 1:0.8, 2:1.
53. The adhesive composition of any one preceding embodiment, which additionally comprises at least one plasticizer.
54. The adhesive composition of embodiment 53, wherein the plasticizer is an ester, in particular a diester or triester.
55. The adhesive composition of embodiment 53 or 54, wherein the plasticizer has a vapour pressure of <10⁻⁴ hPa at 23° C.
56. The adhesive composition of embodiment 53 or 54, wherein the plasticizer is dinonylphthalate.
57. The adhesive composition of any one preceding embodiment, which comprises:
   at least one prepolymer that is made by reacting a polypropylene oxide-based triol with HDI, followed by reacting with a molecule of Formula I which is CPEE,
   a polyamine in which the amine groups are blocked, which is of the Formula VIII:

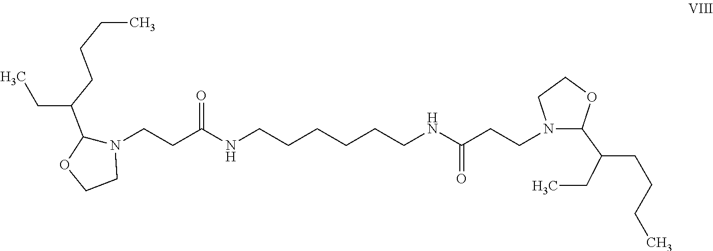 [SMILES: CCCCC(CC)C1OCCN1CCC(=O)NCCCCCCNC(=O)CCN1CCOC1C(CC)CCCC]

or Formula XI:

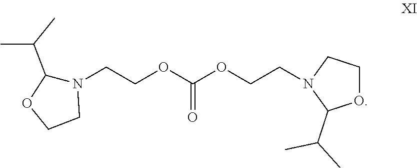 [SMILES: CC(C)C1OCCN1CCOC(=O)OCCN1CCOC1C(C)C]

58. The adhesive composition of any one preceding embodiment, which comprises:
   42-45 wt % of at least one prepolymer that is made by reacting a polypropylene oxide-based triol with HDI, followed by reacting with a molecule of Formula I which is CPEE;
   6-9 wt % of a polyamine in which the amine groups are blocked, which is of the Formula VIII:

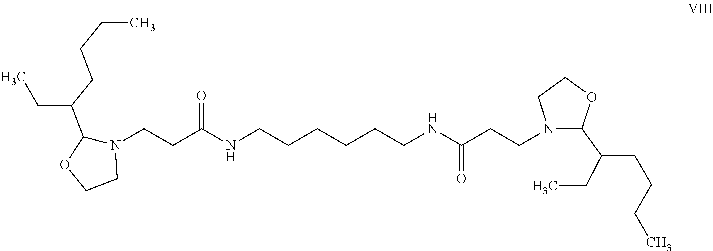 [SMILES: CCCCC(CC)C1OCCN1CCC(=O)NCCCCCCNC(=O)CCN1CCOC1C(CC)CCCC]

or Formula XI:

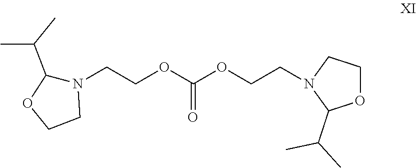 [SMILES: CC(C)C1OCCN1CCOC(=O)OCCN1CCOC1C(C)C]

based on the total weight of the adhesive composition.
59. The adhesive composition of any one preceding embodiment, which comprises:
   42-45 wt % of at least one prepolymer that is made by reacting a polypropylene oxide-based triol with HDI, followed by reacting with a molecule of Formula I which is CPEE;
   6-9 wt % of a polyamine in which the amine groups are blocked, which is of the Formula VIII:

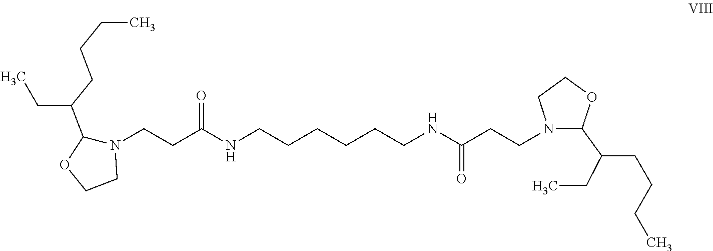 [SMILES: CCCCC(CC)C1OCCN1CCC(=O)NCCCCCCNC(=O)CCN1CCOC1C(CC)CCCC]

or Formula XI:

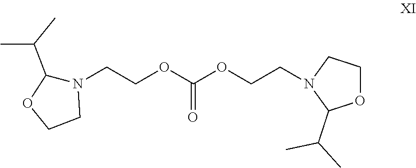 [SMILES: CC(C)C1OCCN1CCOC(=O)OCCN1CCOC1C(C)C]

0.1-0.3 wt % of a catalyst, preferably bismuth neodecanoate;
12-18 wt % of a plasticizer, which is dinonylphthalate;
8-10 wt % of clay;
20-25 wt % carbon black;
based on the total weight of the adhesive composition.
60. A method for adhering a first substrate and a second substrate, comprising the steps:
   (1) applying an adhesive composition according to any one preceding embodiment to the first substrate, the second substrate or both;
   (2) bringing the first substrate and the second substrate into adhesive contact; and
   (3) allowing the adhesive to cure by exposure to humidity.
61. A method for adhering two substrates, comprising the steps:
   (1) providing a one-component, moisture-curable polyurethane adhesive composition according to any one of embodiments 1 to 58;
   (2) applying the adhesive to a first substrate, a second substrate, or both;
   (3) placing the first and second substrates in adhesive contact, whereby the adhesive is sandwiched between them; and
   (4) allowing the adhesive to cure.
62. A method according to embodiment 60 or 61, wherein the first and second substrates are selected from metals, glass and polymers.
63. A method according to embodiment 60 or 61, wherein the first and second substrates are selected from metals.
64. A method according to embodiment 60 or 61, wherein the first and second substrates are steel.
65. A method according to embodiment 60 or 61, wherein the first substrate is metal and the second substrate is a polymer.
66. An adhered assembly comprising:
   (1) a first substrate;
   (2) a second substrate;
   (3) an adhesive composition according to any one of embodiments 1 to 59;
   wherein the first and second substrates are in adhesive contact with the adhesive sandwiched between them.
67. An adhered assembly according to embodiment 66, wherein the first and second substrates are selected from metals, glass and polymers.
68. An adhered assembly according to embodiment 66, wherein the first and second substrates are selected from metals.
69. An adhered assembly according to embodiment 66, wherein the first and second substrates are steel.
70. An adhered assembly according to embodiment 66, wherein the first substrate is metal and the second substrate is a polymer.

### EXAMPLES

TABLE 1
Ingredients

| Trademark | | |
|---|---|---|
| or | | |
| abbreviation | Chemistry | Function |
| Incozol EH | 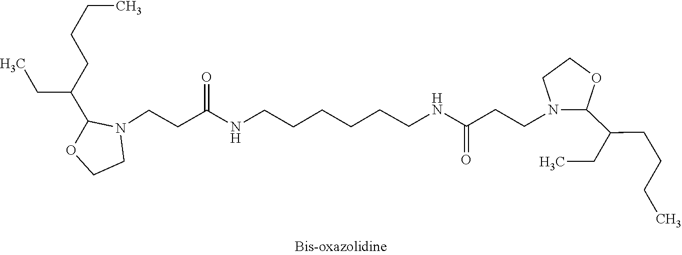 [SMILES: CCCCC(CC)C1OCCN1CCC(=O)NCCCCCCNC(=O)CCN1CCOC1C(CC)CCCC] | Bis- oxazolidine |
| VORANOL CP | Polypropyleneoxide-triol with a MW of 4800 g/mol supplied by | triol |
| 4610 | Dow. | |
| Desmodur H | 1,6-HDI, 1,6-hexamethylenediisocyanate supplied by Covestro | |
| TIB KAT 718 | Mixture of zinc and bismuth carboxylates | Catalyst |
| CPEE | Ethyl-2-oxocyclopentanecarboxylate | Molecule of |
| | | Formula I |
| Bicat 8108 | bismuth(3+) neodecanoate (<80%) with an excess of | catalyst |
| | neodecanoic acid (<40%). | |
| Irganox 1520L | 4,6-Bis(octylthiomethyl)-o-cresol | Phenolic |
| | | antioxidant |
| Vestinol 9 | Di-isononylphthalate | Plasticizer |
| Printex 30 | carbon black filler with an oil absorption number (OAN) | Carbon black |
| | according to ASTM D2414 of 10w cc/100 g. Average primary | filler |
| | particle size according to ASTM D3849 is 85 nm. BET surface | |
| | area according to ASTM D6556 is 85 m²/g | |
| Polestar 200R | Polestar 200R is a medium particle size calcined kaolin clay | Clay filler |
| DABCO LV33 | a solution of 1,4-Diazabicyclo[2.2.2]octane in propylene glycol | Catalyst |
| Clay | Kaolin clay (calcined aluminium silicate) | Clay Filler |
| Cardolite NX- | cardanol | Phenol |
| 2026 | | |
| Desmodur E15 | aromatic diisocyanate prepolymer based on toluene | Aromatic |
| | diisocyanate. | diisocyanate |
| DABCO T-12N | dibutyltin dilaurate | Catalyst |

### Preparation of Polyurethane Prepolymers

Blocked polyurethane Prepolymer 1 was prepared using the ingredients listed in Table 2.

TABLE 2
Composition of Prepolymer 1

| | | Prepolymer 1 |
|---|---|---|
| Ingredient | Nature | (wt %) |
| Voranol CP 4610 | Polyether triol | 82.68 |
| Desmodur H | 1,6-HDI | 8.68 |
| TIB KAT 718 | bismuth catalyst | 0.10 |
| CPEE | Ethyl-2- | 8.54 |
| | oxocyclopentanecarboxylate | |
| Viscosity (23° C., CP4/20, | | 101 |
| up/down Newtonian) (Pas) | | |
| NCO (wt %) | | 0 |
| GPC MWT | | 15,200 |
| GPC polydispersity index | | 23,600 |
| (PDI) | | |

The polyetherpolyol (VORANOL CP 4610) was added into a lab reactor and heated under stirring and vacuum to 130° C. When 130° C. was reached, the mixture was cooled with stirring to 70° C. (material temperature). The vacuum was broken and Desmodur H was added to the lab reactor. The mixture was stirred for 2 min under nitrogen, at which point the catalyst TIB KAT 718 was added. The mixture was allowed to react for 45 min while stirring under nitrogen at 85° C. bath temperature. The isocyanate content was checked and it was 2.37%.

The mixture was cooled to 60° C. under nitrogen and stirring. Once the material temperature reached 60° C. the CPEE was added. The mixture was allowed to react for 45 min under stirring and nitrogen at 85° C. bath temperature. The isocyanate content was checked and found to be 0%.

The mixture was stirred for an additional 20 min under vacuum at 85° C. bath temperature.

Blocked polyurethane Prepolymer 2 was prepared using the ingredients listed in Table 3.

TABLE 3
Composition of Prepolymer 2

| | | Prepolymer 1 |
|---|---|---|
| Ingredient | Nature | (wt %) |
| Cardolite NX-2026 | Cardanol | 22.1 |
| Desmodur E15 | aromatic diisocyanate | 77.85 |
| | prepolymer based on toluene | |
| | diisocyanate | |
| DABCO T-12N | dibutyltin dilaurate | 0.05 |
| Viscosity (23° C., CP4/20, | | 45 |
| up/down Newtonian) (Pas) | | |
| NCO (wt %) | | <0.8 |
| GPC MWT | | 3,500 |
| GPC polydispersity index | | 1.1 |
| (PDI) | | |

The Cardolite NX-2026 and the Desmodur E15 were mixed together and heated to 60° C. The DABCO T-12N catalyst was then added. The mixture was stirred for 45 minutes at 80° C. under nitrogen and then for 10 minutes under vacuum. The mixture was cooled and stored in a closed container.

### Adhesive Formulation

The adhesive formulations were mixed, using the ingredients listed in Table 4, on a planetary mixer or on a dual asymmetric centrifuge. In a first phase the liquid phases were mixed before the solid material was added to the formulation. The formulation was mixed for ca 30 min under vacuum before being filled into cartridges, pails, or drums.

### Test Methods

### Viscosity

Viscosity was measured on a Kinexus rheometer using a plate/cone set-up with a 20 mm diameter cone with 4° angle and a gap of 0.144 mm. The measurement was performed at 23° C. A shear-rate measurement was performed from 0.1 to 10 1/s and the Newtonian viscosity is reported.

### Lap Shear Tests

Lap shear tests were performed according to DIN EN 1465 (GEX21) with glass substrates. Floatglass substrates with a dimension of 100×25×5 mm were used. The substrates were primed with BETAPRIME™ 5500 which is a glass primer. The primer was left to evaporate 15 minutes before the adhesive composition was applied. The adhesive composition was applied and the second substrate was joined. The adhesive overlap area was 25×10 mm, adhesive thickness was 2 mm. Lap shear tests were performed after curing of the adhesive composition as reported in Table 4. The tests were performed on a Zwick tensiometer with a 5 kN force measurement system, with 2 N preload, and 10 mm/min pulling speed. The tests were performed at 23° C., 50% rh.

### Tensile Tests

Tensile tests were performed according to DIN EN ISO 527-2. Dogbones were cut from a 2 mm thick plate that was cured for at least 7 days at 23° C., 50% rh. Preload was 1.5 N, sample width 4 mm, pulling speed was 200 mm/min. A 500 N force measurement system was used with a MuliXtens distance measurement system. Results are reported in Table 4.

### Molecular Weight

Molecular Weight data of the polyurethane prepolymers were measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

### NCO Content

NCO measurements were performed according to ASTM D2572-97 (Reapproved 2010) (GEX081). This test method is applicable for liquids containing isocyanates. There are included monomers (e.g. methylendiphenyldiisocyanate MDI), prepolymers and adhesive formulations. The isocyanate (NCO) sample reacts with an excess of dibutylamine to form the corresponding urea. The NCO content was determined from the amount of dibutylamine consumed in the reaction. The result is reported as percent NCO (weight percent).

### Results

The results of experiments are listed in Tables 4 and 5.

Comparative examples are designated “CE”, and inventive examples are designated “IE”.

TABLE 4
Formulations and key performance data of comparative and inventive examples.
(lap shear test failure modes: adhesive failure (AF), cohesive failure
(CF), superficial cohesive failure (SCF, near to the surface)

| | CE1 | CE2 | CE3 | CE4 | IE1 | IE2 | IE3 |
|---|---|---|---|---|---|---|---|
| Formulation | | | | | | | |
| Prepolymer 1 (wt %) | 100 | — | — | — | 85.9 | 85.6 | 44 |
| Prepolymer 2 (wt %) | — | 100 | — | 79.1 | — | — | — |
| Incozol EH (wt %) | — | — | 100 | 20.5 | 14.1 | 14.0 | 7.23 |
| Bicat 8108 (wt %) | — | — | — | — | — | 0.4 | 0.29 |
| DABCO LV 33 (wt %) | — | — | — | 0.4 | — | — | — |
| Irganox 1520 L (wt %) | — | — | — | — | — | — | 0.57 |
| Vestinol 9 | — | — | — | — | — | — | 16.42 |
| Polstar R 200 (wt %) | — | — | — | — | — | — | 9.00 |
| Printex 30 (wt %) | — | — | — | — | — | — | 22.49 |
| NH/CPEE (NCO) | — | — | — | 1.055 | 1.052 | 1.052 | 1.054 |
| RESULTS | | | | | | | |
| Viscosity initial (Pa · s) | 95 | 40 | 2 | 25 | 64 | 67 | 932 at |
| | | | | | | | 10 1/s |
| Viscosity after 7 d RT (Pa · s) | 129 | 40 | 4.4 | 35 | Solid/cured | Solid/cured | Solid/cured |
| Lap shear strength (MPa) | — | — | — | — | — | — | 2.2 ± 0.3 |
| Tensile strength (MPa) | — | — | — | — | — | — | 2.7 ± 0.1 |
| E-modulus (MPa) | — | — | — | — | — | — | 1.3 ± 0.1 |
| Elongation at break (%) | — | — | — | — | — | — | 455 ± 22 |

TABLE 5
Adhesion peel tests for IE3 immediately after curing, after 7 days
immersion in water, after 7 days at 70° C. and after 7 days
cataplasma treatment

| | | 7 d water | | |
|---|---|---|---|---|
| | | immersion | | 7 d |
| Substrate | 7 d RT | 23° C. | 7 d 70° C. | Cataplasma |
| e-coated | 100% CF | 100% CF | 100% CF | 100% CF |
| steel with | | | | |
| primer | | | | |
| BETAPRIME | | | | |
| 5404 | | | | |
| Glass with | 100% CF | 100% CF | 100% CF | 100% CF |
| primer | | | | |
| BETAPRIME | | | | |
| 5500 | | | | |

(CF = cohesive failure, AF = adhesive failure).

CE1 shows that if just the CPEE protected Prepolymer 1 is exposed to humidity, it does not crosslink and viscosity does not significantly increase after 7d at 23° C., 50% r.h.
CE2 shows that if an isocyanate functional prepolymer that is capped with a common protection group based on a phenol (Prepolymer 2) is exposed to humidity (7d, 23° C.), again no reaction occurs and there is no increase in viscosity after 7d at 23° C.
CE3 shows what happens if bis-oxazolidine is exposed to humidity for 7d at 23° C. This causes hydrolysis of the bis-oxazolidine, converting it into an amine. However, there is no crosslinking taking place which is indicated by still a very low viscosity after 7d at 23° C.
CE4 shows that the conventional blocked polyurethane Prepolymer 2 does not crosslink even in the presence of a bis-oxazolidine.

Inventive example IEl comprises the CPEE blocked prepolymer (Prepolymer 1) in combination with bis-oxazolidine. When the mixture is exposed to humidity, it starts to crosslink and form a cured patty. This crosslinking process can be supported by the addition of a catalyst (Bicat 8108) as demonstrated in inventive example IE2. This technology can be exploited to formulate filled 1 K PU adhesive compositions as demonstrated in inventive example IE3. The adhesive composition from IE3 is in its uncured form a black paste with a good rheology, no sag, and a very short string. After application, it starts to cure with humidity to form a crosslinked PU/Polyamide polymer. The lap shear strength on float glass substrates that were primed with a glass primer BETAPRIME 5500 (15 min flash-off time) is 2.2 MPa with a 100% cohesive failure mode. Tensile tests were performed with specimen cut from a 2 mm thick plate that was cured for 14 days at 23° C. (50% r.h.) and showed a tensile strength of 2.7 MPa, an E-modulus of 1.3 MPa and an elongation at break of 455%. Adhesion tests were performed on float glass and e-coated steel substrates. The glass substrates were primed with a glass primer BETATPRIME 5500, the e-coated steel substrates were primed with a black primer BETAPRIME 5404. Peel adhesion tests were performed after 7 days curing at 23° C. 50% relative humidity, after 7d at 23° C. followed by immersion for 7d in water at 23° C., after 7d RT followed by 7d water immersion followed by 70° C. exposure, as well as after 7d RT followed by 7d water immersion, followed by 7d 70° C. exposure followed by 7d cataplasma exposure (70° C., 100% rh). All peel adhesion tests showed 100% cohesive failure mode, indicating that good adhesion is observed on primed glass substrates. Cure rate tests showed, that within 48 hours the material cured through a thickness of 3 mm.

1. A one-component, moisture-curable polyurethane adhesive composition comprising:
(A) a polyurethane prepolymer made by reacting at least one polyisocyanate and at least one polyol (resulting in Intermediate I), followed by reaction with a molecule of Formula I: 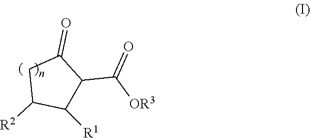
where R¹ and R² are independently selected from hydrogen and C₁ to C₆ alkyl, n is an integer from 1 to 2, and R³ is C₁ to C₆ alkyl;
(B) a polyamine in which the amine groups are blocked with a group that is cleaved on exposure to humidity;
(C) optionally a catalyst capable of catalyzing the reaction of an amine with the moiety resulting from the molecule of Formula I.

2. The adhesive composition of claim 1, wherein the at least one polyol is a polyether polyol or a polyester polyol.

3. The adhesive composition of claim 1, wherein the at least one polyol is a polyether polyol.

4. The adhesive composition of claim 1, wherein the at least one polyol is a diol, triol or tetra-ol, or a mixture thereof.

5. The adhesive composition of claim 1, wherein the at least one polyol is selected from polyoxyethylene, polyoxypropylene, polyoxybutylene, and polytetramethylene ether diols and triols.

6. The adhesive composition of claim 1, wherein the polyol is a polypropylene oxide-based diol or triol or a mixture of these.

7. The adhesive composition of claim 1, wherein the polyol is a polypropylene oxide-based triol.

8. The adhesive composition of claim 1, wherein the at least one polyisocyanate is a diisocyanate.

9. The adhesive composition of claim 1, wherein the at least one polyisocyanate is an aliphatic polyisocyanate.

10. The adhesive composition of claim 1, wherein the at least one polyisocyanate is hexamethylene diisocyanate (HDI).

11. The adhesive composition of claim 1, wherein the at least one polyurethane prepolymer is made by reacting a polypropylene oxide based triol with HDI.

12-15. (canceled)

16. The adhesive composition of claim 1, wherein the prepolymer comprises the at least one polyol in an amount from 40 to 95 wt % based on the total weight of the polyurethane prepolymer.

17-18. (canceled)

19. The adhesive composition of claim 1, wherein the prepolymer comprises the at least one polyisocyanate in an amount from 4 to 15 wt % based on the total weight of the polyurethane prepolymer.

20-21. (canceled)

22. The adhesive composition of claim 1, wherein in the molecule of Formula I, R¹ and R² are independently selected from H and C₁ to C₄ alkyl.

23. (canceled)

24. The adhesive composition of claim 1, wherein in the molecule of Formula I, R¹ and R² are H.

25-30. (canceled)

31. The adhesive composition of claim 1, wherein the molecule of Formula I is ethyl 2-(ethoxycarbonyl)cyclopentanone (CPEE).

32-36. (canceled)

37. The adhesive composition of claim 1, wherein the at least one polyurethane prepolymer is made by reacting a polypropylene oxide-based triol with a molecular weight of 4,800 Da with HDI, followed by reacting with a molecule of Formula I, which is CPEE, wherein the polyol is used at 82-83 wt %, the HDI is used at 8-9 wt % and the CPEE is used at 8-9 wt %, based on the total weight of the polyurethane prepolymer.

38-41. (canceled)

42. The adhesive composition of claim 1, wherein the polyamine in which the amine groups are blocked is a polyoxazolidine of Formula II or Formula III: 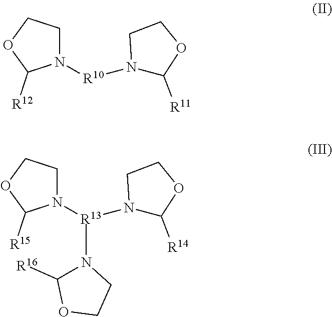
where, in Formula II, R¹⁰ is a branched or unbranched divalent organic radical, R¹¹ and R¹² are independently selected from H and branched or unbranched C₁-C₈-alkyl, and
in Formula III, R¹³ is a branched or unbranched trivalent organic radical, and R¹⁴, R¹⁵ and R¹⁶ are independently selected from H and branched or unbranched C₁-C₈-alkyl.

43. The adhesive composition of claim 1, wherein the polyamine in which the amine groups are blocked is a polyoxazolidine of Formula V, Formula VI or Formula XII: 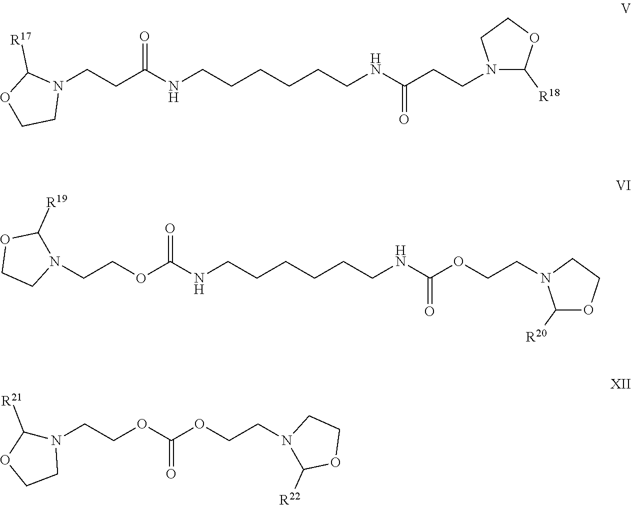
where in Formula V, R¹⁷ and R¹⁸ are independently selected from H and branched or unbranched C₁-C₈-alkyl, preferably C₇-alkyl, and in Formula VI, R¹⁹ and R²⁰ are independently selected from H and branched or unbranched C₁-C₈-alkyl, preferably C₇-alkyl, and in Formula XII, R²¹ and R²² are independently selected from branched or unbranched C₁-C₈-alkyl, preferably C₃-alkyl.

44. The adhesive composition of claim 43, wherein, in Formula V, R¹⁷ and R¹⁸ are of the formula:

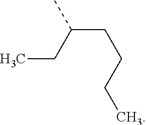

45-70. (canceled)
